(19) United States
(12) Patent Application Publication
(10) Pub. No.: US 2024/0372738 A1
(43) Pub. Date: Nov. 7, 2024

(54) GENERATING BLOCKCHAIN TRANSACTIONS

(71) Applicant: nChain Licensing AG, Zug (CH)

(72) Inventors: Bassem AMMAR, London (GB); Craig Steven WRIGHT, London (GB)

(21) Appl. No.: 18/690,477

(22) PCT Filed: Aug. 15, 2022
(86) PCT No.: PCT/EP2022/072787

§ 371 Date: Mar. 8, 2024

(30) Foreign Application Priority Data
Sep. 14, 2021 (GB) 2113092.7

(51) Int. Cl. H04L 9/00; H04L 9/32

(52) U.S. Cl. CPC H04L 9/50; H04L 9/3252

(57) ABSTRACT

A computer-implemented method of generating a blockchain transaction, wherein each party of a plurality of second parties has a respective secret number k from which a respective r-portion is derivable, wherein a Merkle tree is defined, at least one leaf node of the Merkle tree being based on at least one of the respective r-portions, wherein the method is performed by a first party and comprises: generating a first blockchain transaction, wherein the first blockchain transaction comprises a first locking script comprising a target Merkle tree portion corresponding to the Merkle tree, the first locking script configured, when executed together with a first unlocking script of a second blockchain transaction, to: extract an r-portion from the first unlocking script, generate a hash value derived from the extracted r-portion, calculate a candidate Merkle tree portion based on the generated hash and a Merkle proof portion of the first unlocking script, verify that the calculated candidate Merkle tree portion matches the target Merkle tree portion, verify a signature portion of the first unlocking script based on a public key of the first unlocking script, and making the first blockchain transaction available to one or more nodes of a blockchain network.

### CROSS REFERENCE TO RELATED APPLICATIONS

This application is the U.S. National Stage of International Application No. PCT/EP2022/072787 filed on Aug. 15, 2022, which claims the benefit of United Kingdom Patent Application No. 2113092.7, filed on Sep. 14, 2021, the contents of which are incorporated herein by reference in their entireties.

### TECHNICAL FIELD

The present disclosure relates to a method of generating an output of a blockchain transaction that can be unlocked by any individual or threshold of individuals, and a method of generating a blockchain transaction for unlocking such an output.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below.

Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

In a blockchain transaction, typically a UTXO is locked to a pre-defined user or users, by including in the locking script the public key of the recipient. However, there may be situations in which the recipient of the UTXO is unknown at the time of generating the locking script.

According to one aspect disclosed herein, there is provided a computer-implemented method of generating a blockchain transaction, wherein each party of a plurality of second parties has a respective secret number k from which a respective r-portion is derivable, wherein a Merkle tree is defined, at least one leaf node of the Merkle tree being based on at least one of the respective r-portions, wherein the method is performed by a first party and comprises: generating a first blockchain transaction, wherein the first blockchain transaction comprises a first locking script comprising a target Merkle tree portion corresponding to the Merkle tree, the first locking script configured, when executed together with a first unlocking script of a second blockchain transaction, to: extract an r-portion from the first unlocking script, generate a hash value derived from the extracted r-portion, calculate a candidate Merkle tree portion based on the generated hash and a Merkle proof portion of the first unlocking script, verify that the calculated candidate Merkle tree portion matches the target Merkle tree portion, verify a signature portion of the first unlocking script based on a public key of the first unlocking script, and making the first blockchain transaction available to one or more nodes of a blockchain network.

The r-portion corresponds to an “R-puzzle”, which is a form of knowledge proof. This allows a user to unlock the UTXO using any valid public-private keypair, which are independent of the locking script, provided the user knows the secret number k which is used to derive r. Therefore, the UTXO can be locked knowing the r-puzzle, and subsequently the secret value k can be provided to the recipient without any need to alter the previous transaction in which the UTXO is locked. That is, the transaction locking the UTXO can be generated without knowledge of the recipient.

Merkle trees are another form of knowledge proof. The unlocker must know both the data from which the leaf node is derived and a Merkle proof, which provides the information required to calculate the Merkle root of a Merkle tree. Therefore, by combining r-puzzles with the Merkle tree, the unlocker must know the secret value k, from which the leaf node is derived, and the Merkle proof corresponding to that particular leaf node.

Thus, the disclosed method improves both flexibility of the blockchain transaction and confidentiality for external parties. Flexibility is improved by allowing any one or any set of a group of users to unlock the transaction, whilst confidentiality is improved by requiring the user(s) to have knowledge of a range of data items (namely, the Merkle proof portion, the signature portion, and the public key).

The use of the Merkle tree in script also provides a more efficient and scalable method to known threshold unlocking schemes. This is because the locking script does not comprise all of the keys which may be used to unlock the UTXO, or all of the possible sets of keys in the case of an M-of-N scheme.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of some node software for processing transactions,

FIG. 5 shows an example Merkle tree;

FIGS. 6A-6D schematically illustrate some of the principles behind an elliptic curve digital signature algorithm (ECDSA),

FIG. 7 schematically illustrates a method of using R-puzzles and Merkle trees for a 1-of-N signature unlocking requirement,

FIG. 8 schematically illustrates a method of using R-puzzles and Merkle trees for an M-of-N signature unlocking requirement,

FIG. 9 schematically illustrates a method of using R-puzzles, Merkle trees, and in-script elliptical curve point addition for an M-of-N signature unlocking requirement,

FIG. 10 schematically illustrates an alternative method of using R-puzzles, Merkle trees, and in-script elliptical curve point addition for an M-of-N signature unlocking requirement, and

FIGS. 11A-C schematically illustrates Merkle paths in a given Merkle tree given different Merkle portions of a locking script.

### DETAILED DESCRIPTION OF EMBODIMENTS

### Example System Overview

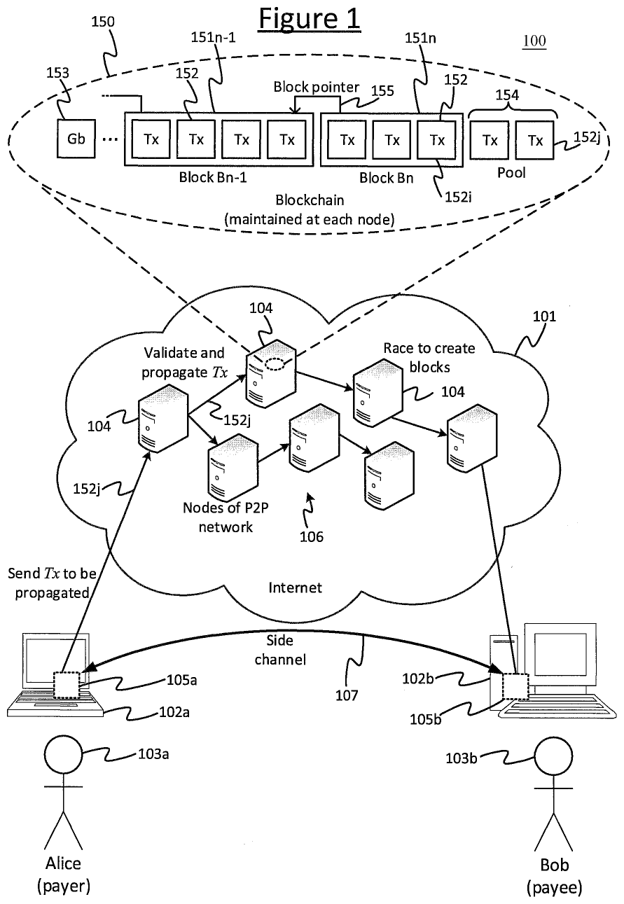

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n−1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

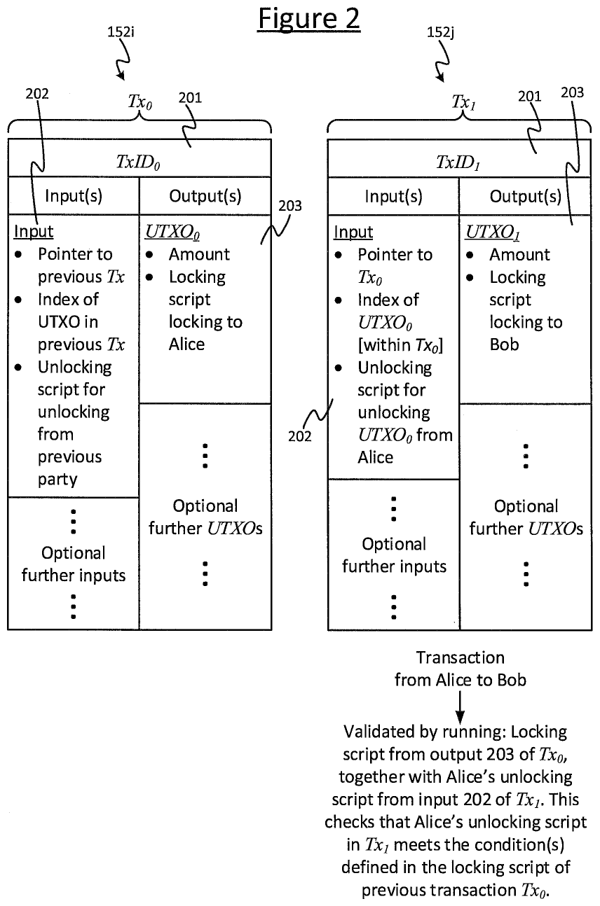

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>∥[Checksig P_{A}]

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### Client Software

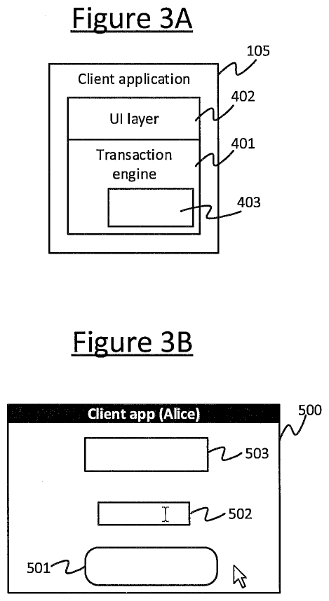

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly. In accordance with embodiments disclosed herein, the transaction engine 401 of each client 105 comprises a function 403 which derives one or more of: a Merkle tree with leaf nodes based on one or more r-portions, a Merkle root corresponding to the Merkle tree, a Merkle proof corresponding to the Merkle tree, an r-portion derived from a secret value k, a combined r-portion based on two or more of the derived r-portions, and a gradient λ between two elliptic curve points.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands). The options enable the user (Alice) to select one or more of: a secret values k from which an r-portion is derived, and a Merkle tree or identifier thereof.

Alternatively or additionally, the UI elements may comprise one or more data entry fields 502, through which the user can input select one or more of: a secret values k from which an r-portion is derived, and a Merkle tree or identifier thereof. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### Node Software

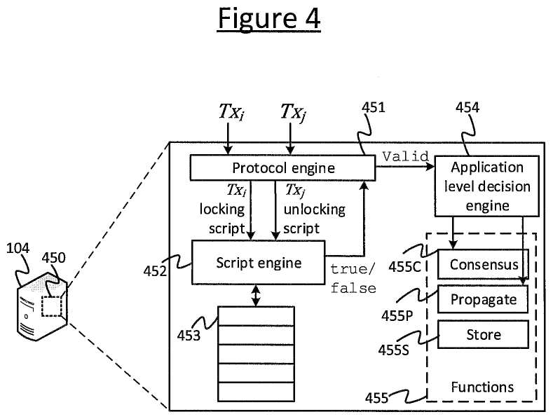

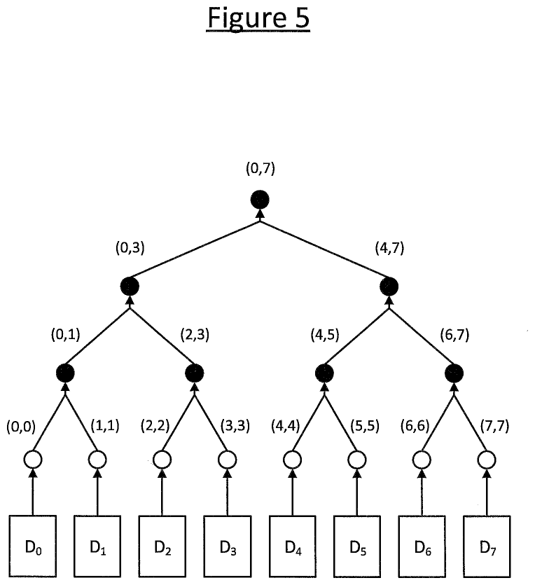

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### R-Puzzles

### Elliptical Curve Digital Signature Algorithms (ECDSAs)

Public key cryptography is used as a basis for securing transactions in a number of different blockchain architectures. Uses of public key cryptography include public key encryption and digital signature schemes. Public key cryptography is founded on the principle that certain functions are easy to compute but hard to reverse without some special knowledge. Such a function is called a trapdoor function and the special knowledge needed to reverse it is referred to as a trapdoor of that function. Easy to compute means it is computationally feasible to compute the trapdoor function for a given input (or set of inputs) in a reasonable time frame, and hard to reverse that it is computationally infeasible to infer that input (or those inputs) from the result without knowledge of the trapdoor.

In the context of public key cryptography, a key pair means a public key (which can be made freely available to anyone) and a corresponding private key (which is assumed to be secret in the sense that it is only known to a specific entity or group). The public key defines a trapdoor function and the corresponding private key is the trapdoor needed to reverse that function.

In a public key encryption context, encryption is based on the trapdoor function (i.e. encryption is performed in the “forward direction”), whereas decryption is based on the reversal the trapdoor function (i.e. decryption is performed in the “reverse direction”) which is only feasible when the trapdoor is known.

In a digital signature context, signature verification is performed in the forward direction, using the public key, and signature generation is performed in the reverse direction and can only feasibly be performed using the private key.

In a blockchain context, digital signatures based on public key cryptography are used as a basis for cryptographically signing transactions and verifying transaction signatures.

ECC is a form of public key cryptography which harnesses the mathematical properties of elliptical curves, and has various benefits over other cryptographic schemes such as DSA (Digital Secure Algorithm).

The “Elliptic Curve Digital Signature Algorithm” (ECDSA) refers to a class of digital signature schemes which use ECC as a basis for digital signature generation and verification. Certain principles of the ECDSA are outlined below.

In mathematical terminology, ECC exploits the algebraic structure of elliptic curves over finite fields of prime order. A finite field means a finite set of elements and a set of associated operations of multiplication, addition, subtraction and division which satisfy the normal rules of arithmetic (associativity, commutativity etc.) when applied to the elements in the set. That is to say, operations which need not be addition, multiplication etc. in the “normal” sense, but which do behave in essentially the same way.

### Elliptic Curve Operations

In the context of ECC, the addition, subtraction and multiplication operations are, respectively, elliptic curve point addition, denoted “+” herein, elliptic curve point subtraction, denoted “−” herein, and elliptic curve scalar multiplication, denoted “·” herein. The addition and subtraction operations are each applied to two points on an elliptic curve and return a third point on the elliptic curve; however, the multiplication operation is applied to a scalar and a single point on an elliptic curve, and returns a second point on the elliptic curve. Division is, by contrast, defined on scalars.

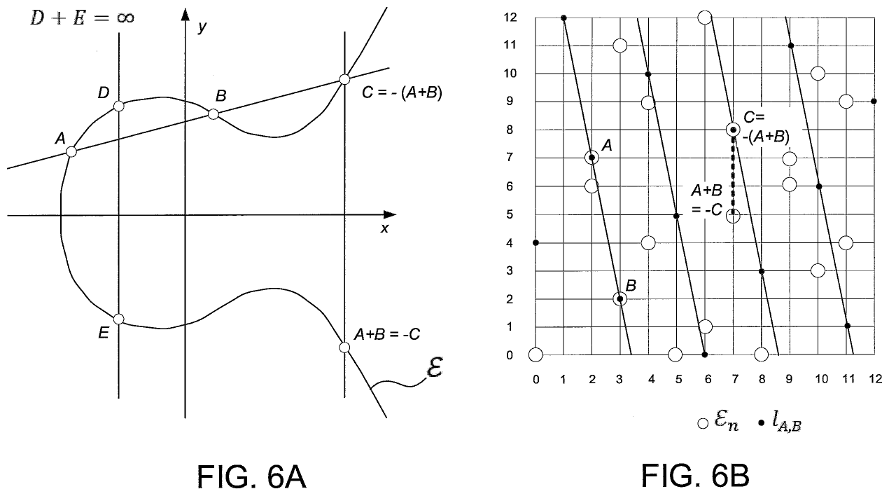

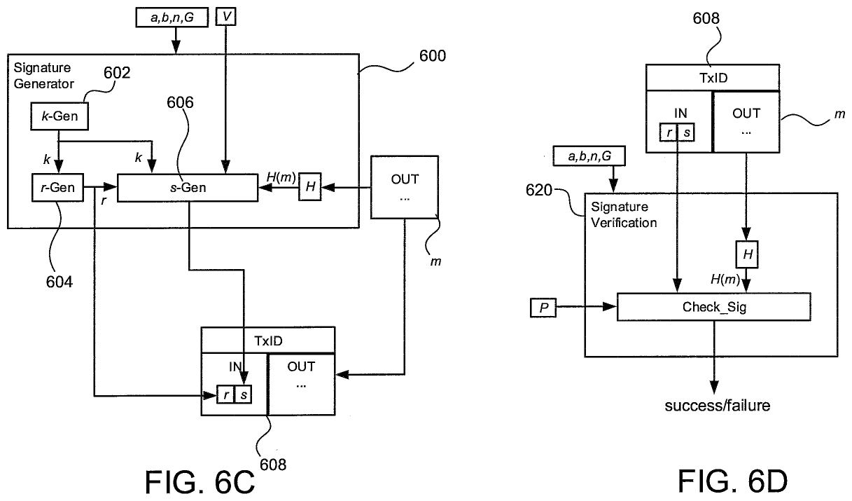

For the purposes of illustration, FIG. 6A shows an elliptic curve ε in [symbol] ², [symbol] ² being the set of all real-valued two-dimensional coordinates and (x, y)∈ [symbol] ² denoting an element of [symbol] ². The elliptical curve ε is the set of points which satisfy the following equation:

$$ε : {y}^{2} = {x}^{3} + a x + b$$

Addition: A mathematical property of ε is that, given any two points A, B on the elliptic curve ε, a line intersecting A and B will re-intersect ε and one additional point only, denoted C; the elliptic curve addition of A and B, i.e. A+B, is defined as the “reflection” of C: taking the horizontal line which intersects C, the reflection of C is the other point on the elliptic curve intersected by that line. This definition hold for the case A=B, with the modification that C is now the point at which the tangent to ε at A re-intersects ε. This definition is made to hold for the case that the line intersecting two points is vertical by defining a point at infinity, denoted ∞, as a point on the elliptic curve and at which any vertical line intersects the elliptic curve (e.g. the points labelled D and E are vertically horizontally aligned, hence D+E=∞).
Subtraction/additive inverse: The above definition of reflection applies to any point, and provides the definition of elliptic curve point subtraction: A−B is the sum of A with the reflection of B. The reflection of B is more formally referred to as the “additive inverse” of B, which in turn is denoted −B. Using this notation, elliptic curve subtraction can be defined in mathematical notation as:

$$A - B = A + ( - B ) .$$

Hence, in FIG. 6B, C=−(A+B) and (A+B)=−C. Note also that, under this definition, D=−E, which reflects a general rule of the algebraic structure, namely that the elliptic point addition of any point on the elliptic curve with its additive inverse is the point at infinity, i.e.

$$A + ( - A ) = ∞ ∀ A ∈ ε$$

The point at infinity ∞ is more formally referred to as an “identity element” (note both the parallel with and the deviation from normal arithmetic: in normal arithmetic, the sum of any number a with its additive inverse −a is 0, with 0 being the identity element for normal arithmetic). Another property of the identity element, ∞ which mirrors normal arithmetic, is that A+∞=A for any point A on ε including ∞ itself (analogous to the statement a+0=0 for any real number a)
Multiplication: From the definition of elliptic curve point addition, the definition of elliptic curve scalar multiplication follows: the multiplication of an elliptic curve point A with an integer ν is defined as:

$$v \cdot A = {\underbrace{A + … + A}}_{v times} .$$

That is, as ν elliptic curve point additions of A with itself.

Note: elliptic curve scalar multiplication is also referred to in the art as elliptic curve point multiplication. Those two terms have the same meaning in the present disclosure.
Division/multiplicative Inverse: The operation of division is defined with respect to scalars: given a scalar ν, its “multiplicative inverse” is defined at the scalar ν⁻¹ such that:

$$v {v}^{- 1} = 1 .$$

FIG. 6A provides an intuitive visualization of the above operations, in which ε is defined over an infinite field comprising all real-numbers [symbol] .

FIG. 6B more closely represents how the above operations are actually applied in the context of ECC, as it shows an elliptic curve εₙ defined by the equation:

$${ε}_{n} \text{:} {y}^{2} = {x}^{3} + a x + b mod p$$

where p is a prime number (the prime modulus) and mod denotes the modulo operation. The set of points which satisfy the above equation is finite, and all but one of those points are represented in FIG. 6B as white circles; the remaining point is the identity element ∞. The prime number p forms part of the definition of the elliptic curve, and can be freely chosen. For the elliptic curve to have good cryptographic properties, p should be sufficiently large. For example, a 256 bit p is specified in certain blockchain models.

The subscript “n”, by contrast, is referred to herein as the order of the group formed by the elliptic curve points under the point addition defined above (as shorthand, this may be called the order of the elliptic curve εn)—see below.

In other words, n is the order of the group, and p is the order of the field. There will be n elliptic curve points in total. Each point on the elliptic curve is represented by two numbers/coordinates (x, y), where x and y are all in the range −(p−1), . . . 0, . . . , (p−1).

It can be seen that εₙ in FIG. 6B exhibits a horizontal symmetry which is analogous to that of ε in FIG. 6A, which is a general property of elliptic curves over prime files, hence the definition of the additive inverse of a point on εₙ still holds. Some points have no horizontally-aligned counterpoint (e.g. (0,0)) and such points are their own additive inverse.

The “line” l_{A,B} intersecting two points A and B on εₙ becomes a finite set of points, represented by smaller black circles, satisfying analogous geometric requirements, and the definition of elliptic curve scalar multiplication still holds. Analogous with FIG. 6A, FIG. 6B shows the point A+B=−C, which is the additive inverse of the point C=−(A+B) at which the line l_{A,B} re-intersects εₙ.

The elliptic curve addition A+B=−C of any two points on εₙ can be defined algebraically by the following equations:

$$A = ( {x}_{A} , {y}_{A} ) ,$$

$$B = ( {x}_{B} , {y}_{B} ) ,$$

$$C = ( {x}_{C} , {y}_{C} ) = - ( A + B ) ,$$

$${x}_{C} = ( {λ}^{2} - {x}_{A} - {x}_{B} ) mod p ,$$

$$\begin{matrix}{y}_{C} = ( λ ( {x}_{C} - {x}_{A} ) + {y}_{A} ) mod p , \\ = ( λ ( {x}_{C} - {x}_{B} ) + {y}_{B} ) mod p ,\end{matrix}$$

$$where$$

$$λ = ( {y}_{A} - {y}_{B} ) {( {x}_{A} - {x}_{B} )}^{- 1} mod p \qquad if A \neq B ,$$

$$and$$

$$λ = {( 2 {y}_{A} )}^{- 1} ( 3 {x}_{A}^{2} + a ) mod p \qquad if A = B .$$

For the purposes of the above, the definition of the multiplicate inverse ν⁻¹ of an integer ν is modified as:

$${v}^{- 1} v ≡ 1 ( mod p ) .$$

That is, the multiplicate inverse of the integer ν is the modular inverse of ν mod p.

The case of B=−A is special, and resolved by the introduction of the identity element ∞—as noted, in that case A+B=A+ (−A)=∞. The case of B=∞ is also a special case, resolved as noted above as A+∞=A.

The definition of elliptic curve scalar multiplication adopts this definition of elliptic curve addition and otherwise remains the same.

In other contexts, the definition of the multiplicative inverse ν−1 of a scalar ν with respect is:

$${v}^{- 1} v ≡ 1 ( mod n )$$

It will be clear in context whether a multiplicative inverse is defined with respect to mod n or mod p.

In practice, to identify whether a number should be treated as mod n or mod p, the following checks may be applied:
1. Is the number representing a coordinate of an EC point?
   a. If yes, then mod p
2. Is the number to be used to multiply an EC point?
   a. If yes, then mod n

Note that, there are occasions where both checks give positive answer, in which case that the number has to be mod p and mod n.

### Elliptic Curve Cryptography (ECC)

Elliptic curve arithmetic provides unique capabilities in obscuring a secret value and forms the basis of many contemporary cryptographic systems. In particular, reversing scalar multiplication of elliptic curve points over finite fields is an intractable problem (it is computationally infeasible to perform).

A private key V takes the form of an integer, and the corresponding public key P is a point P on the elliptic curve εₙ derived from a “generator point” G, which is also a point on the elliptic curve εₙ, as:

$$P = V \cdot G = {\underbrace{G + … + G}}_{V times}$$

where ‘·’ denotes elliptic curve scalar multiplication on the elliptic curve εₙ defined by a, b and n (the elliptic curve parameters).

For a sufficiently large V, actually performing V elliptic curve additions to derive P is hard, i.e. computationally infeasible. However, if V is known, then P can be computed much more efficiently by exploiting the algebraic properties of the elliptic curve operations. An example of an efficient algorithm that can be used to compute P is the “double and add” algorithm—crucially, this can only be implemented if V is known.

Conversely, if V is not known, then there is no computationally feasible way of deriving V (i.e. reversing the scalar multiplication) even if both G and P are known (this is the so-called “discrete-logarithm problem”). An attacker could attempt to “brute force” P by starting from G and repeatedly performing elliptic curve point additions until he gets to P; at that point, he would know V to be the number of elliptic curve point additions he had to perform; but that turns out to be computationally infeasible. Hence, V satisfies the requirements of a trapdoor in the above sense.

In ECC, the public key P, generator key G and elliptic curve εₙ are public and assumed to be known, whereas the private key V is secret.

### Elliptic Curve Digital Signature Verification Algorithm (ECDSA)

In a blockchain system, a user or other entity will typically hold a private key V that is used to prove their identity and the corresponding public key P would be calculated by:

$$P = V \cdot G$$

The private key V can be used sign a piece of data m (“the message”) using the ECDSA.

Further details of the ECDSA may for example be found in the following, which is incorporated herein by reference in its entirety: “RFC 6979—Deterministic Usage of the Digital Signature Algorithm (DSA) and Elliptic Curve Digital Signature Algorithm (ECDSA)”, Tools.ietf.org, 2019.

FIG. 6C shows a schematic functional block diagram of a signature generation function (signature generator_600 which generates an ECDSA signature (r, s) for a public key-private key pair (V, P). The ECDSA signature is a pair of values, referred to herein as the r-part (r) and s-part(s) respectively.

The signature generation is based on the same elliptic curve εₙ and generator point G used to derived the public key P, hence the elliptic curve parameters a, b and n and the generator point G are shows as inputs to the signature generator 600.

An ephemeral key generator 602 of the signature generator 600 generates an “ephemeral” key k∈[1, n−1], i.e. in the range from 1 to n−1 inclusive.

An r-part generator 604 calculates a corresponding public ephemeral key from k as follows:

$$R = k \cdot G$$

and then take the x-coordinate (with [ ]ₓ denoting the process of taking the x coordinate of an elliptic curve point) of the calculated point:

r=[R]ₓmod n

which is the r-part of the signature.

As s-part generator 606 calculates an s-part of signature(s) using the modular inverse k⁻¹ of k mod n (i.e. such that k⁻¹k≡1 (mod n)—see above) and a hash of the message m, denoted H(m) (truncated if necessary) as follows:

$$s = {k}^{- 1} ( H ( m ) + rV ) mod n$$

In the present example, the message m comprises data to be included in a transaction 608 (one or more transaction outputs in the present example). This may be referred to as the process of signing the message m, and the message m may be referred to as a signed part of the transaction.

The message m and the signature (r, s), in turn, form part of the transaction 608. In the present example, the signature (r, s) in included in an input of the transaction 608 as part of an unlocking script.

FIG. 6D shows a schematic functional block diagram of a signature verification function (signature verifier) 620 for verifying the transaction 608. The calculations performed by the signature verifier 620 are based on the same elliptic curve εₙ and generator point G which, as noted, are public.

Whilst the signature requires the private key Vas input, that is, one requires knowledge of it in order to generate a valid signature, only the signature pair (r, s), the message m, and the public key P are needed to validate the signature (r, s). In order to verify the signature, the signature verifier 620 hashes the signed part of the transaction m (applying the same hash function H as used to generate the signature (r, s)). The verification process is then performed using the following calculation:

$${R}^{′} = H ( m ) {s}^{- 1} \cdot G + {rs}^{- 1} \cdot P$$

The signature is valid (i.e. the signature verification will succeed) if and only if [R′]ₓ mod n=r, otherwise it is invalid (i.e. the signature verification fails). In the present example, r denotes the r-part of the signature included in the transaction 608.

The public key P used in the signature verification process could for example be specified in the locking script of a preceding transaction. The signature verification is performed, in that case, using the public key specified in the locking script of the preceding transaction, and the signed part m and the signature (r, s) of the (later) transaction 608—and will fail unless the signature (r, s) has been generated based the private key V corresponding to the public key P specified in the preceding transaction and the signed part m of the later transaction 608. Hence, only the person who holds the private key V can claim the output of the preceding transaction (typically by including their own public key in the output of the later transaction 608), and the signed part m of the later transaction 608 cannot be altered without invalidating the signature (r, s).

### Knowledge Proof

An “r-puzzle” is a type of transaction script that allows the spending party to sign the input UTXO using any valid public-private keypair. The key pair can be application-specific or randomly generated for one-off use.

In such a knowledge proof, the signer derives the r-part of the signature (r, s) using a secret number k.

An example locking script that uses an r-puzzle can have the following form:
OP_OVER OP3 OP_SPLIT OP_NIP OP_1 OP_SPLIT OP_SWAP OP_SPLIT OP_DROP OP_HASH160<HASH(r)> OP_EQUALVERIFY OP_CHECKSIG

It will be appreciated that any opcode that performs hashing would be used instead of OP_HASH160, for example, OP_RIPEMD160, OP_SHA1, OP_SHA256, or OP_Hash256.

For brevity, the locking script can be represented as:
OP_OVER [Extract_r] OP_HASH160<HASH(r)> OP_EQUALVERIFY OP_CHECKSIG
   where Extract_r is an abbreviation for a collection of op-codes that extracts the r from the signature. Extract_r is given by:
OP3 OP_SPLIT OP_NIP OP_1 OP_SPLIT OP_SWAP OP_SPLIT OP_DROP

The above script drops the first 3 bytes of the signature, then extracts the r part of the signature, then drops the rest of the signature.

The unlocking script has the following form:
<Sig><PK>
   where the signature takes the form (r, s), r being derived from the secret number k, and <PK> is the public key of the signer.

The signer, who provides the unlocking script, should know r such that kG=(x, y) and r=x mod n, i.e., the signer knows k which when multiplied by G produces a point whose x-coordinates is r when taken modulus n.

<Hash (r)> is provided in the locking script and therefore is public. The secret is k. The script execution is in the following table.

| Main Stack | Script |
|---|---|
| | <Sig><PK>OP_OVER [Extract_r] OP_HASH160 |
| | <HASH(r)> OP_EQUALVERIFY OP_CHECKSIG |
| <Sig><PK> | OP_OVER [Extract_r] OP_HASH160 <HASH(r)> |
| | OP_EQUALVERIFY OP_CHECKSIG |
| <Sig><PK><Sig> | [Extract_r] OP_HASH160 <HASH(r)> |
| | OP_EQUALVERIFY OP_CHECKSIG |
| <Sig><PK><r_{extracted}> | OP_HASH160 <HASH(r)> OP_EQUALVERIFY |
| | OP_CHECKSIG |
| <Sig><PK><Hash(r_{extracted})> | <HASH(r)> OP_EQUALVERIFY OP_CHECKSIG |
| <Sig><PK><Hash(r_{extracted})> | OP_EQUALVERIFY OP_CHECKSIG |
| <HASH(r)> | |

We pass to the following stage if the hash of the
extracted r equals the value in the L.S.

| | |
|---|---|
| <Sig><PK> | OP_CHECKSIG |

<True if correct message is signed with the secret
key that corresponds to the public key>

The signer can use any private-public key pair to sign the message. This is because neither the private key nor the corresponding public key is used in creating the locking script. Therefore, the party providing the locking script does not need to know who will provide the unlocking script at the time of generating the transaction.

A pay-to-R-Puzzle can also be represented as P2RP HASH(r).

### Signature Trees

### Merkle Trees

Merkle Trees are hierarchical data structures that enable secure verification of collections of data. In a Merkle tree, each node in the tree has been given an index pair (i, j) and is represented as N(i, j). The indices i, j are simply numerical labels that are related to a specific position in the tree.

An important feature of the Merkle tree is that the construction of each of its nodes is governed by the following equations

$$N ( i , j ) = \{ \begin{matrix}H ( {D}_{i} ) & i = j \\ H ( N ( i , k ) ‖ N ( k + 1 , j ) ) & i \neq j\end{matrix} ,$$

where and H is a cryptographic hash function.

A binary Merkle tree constructed according to these equations is shown in FIG. 5. As shown, we can see that the i=j case corresponds to a leaf node, which is simply the hash of the corresponding i^{th} packet of data Dᵢ. The i≠j case corresponds to an internal or parent node, which is generated by recursively hashing and concatenating child nodes until one parent (the Merkle root) is found.

For example, the node N(0,3) is constructed from the four data packets D₀, . . . , D₃ as

$$\begin{matrix}N ( 0 , 3 ) = H ( N ( 0 , 1 ) ‖ N ( 2 , 3 ) ) \\ = [ H ( N ( 0 , 0 ) ‖ N ( 1 , 1 ) ) ‖ H ( N ( 2 , 2 ) ‖ N ( 3 , 3 ) ) ] \\ = [ H ( H ( {D}_{0} ) ‖ H ( {D}_{1} ) ) ‖ H ( H ( {D}_{2} ) ‖ H ( {D}_{3} ) ) ]\end{matrix} .$$

The tree depth M is defined as the lowest level of nodes in the tree, and the depth m of a node is the level at which the node exists. For example, mᵣₒₒₜ=0 and m_{leaf}=M, where M=3 in FIG. 5.

For Merkle trees in Bitcoin and some other blockchains, the hash function is double SHA256, which is to apply the standard hash function SHA-256 twice: H(x)=SHA256 (SHA256 (x)).

### Merkle Proofs

The primary function of a Merkle tree is to verify that some data packet Dᵢ is a member of a list or set of N data packets [symbol] ∈{D₀, . . . , D_{N-1}}. The mechanism for verification is known as a Merkle proof and involves obtaining a set of hashes known as the Merkle path for a given data packet Dᵢ and Merkle root R. The Merkle proof for a data packet is simply the minimum list of hashes required to reconstruct the root R by way of repeated hashing and concatenation, often referred to as the ‘authentication proof’.

A proof of existence could be performed trivially if all packets D₀, . . . , D_{N-1} and their order are known to the prover. This does however require a much larger storage overhead than the Merkle proof, as well as requiring that the entire data set is available to the prover. The comparison between using a Merkle proof and using the entire list is shown in the table below, where we have used a binary Merkle tree and assumed that the number of data blocks N is exactly equal to an integer power 2.

The following table shows the relationship between the number of leaf nodes in a Merkle tree and the number of hashes required for a Merkle proof (or Merkle proof).

| | | | | | Merkle tree |
|---|---|---|---|---|---|
| No. data packets | 32 | 256 | 1024 | 1048576 | N = 2^{M} |
| No. hashes required | 5 | 8 | 10 | 20 | M = log₂ N |
| for proof of existence | | | | | |

In this simplified scenario—where the number of data packets is equal to the number of leaf nodes—we find that the number of hash values required to compute a Merkle proof scales logarithmically. It is clearly far more efficient and practical to compute a Merkle proof involving log₂ N hashes than to store N data hashes and compute the explicit proof.

### Method

If, given a Merkle root R, we wish to prove that the data block D₀ belongs to the ordered list [symbol] £{D₀, . . . , D_{N-1}} represented by R we can perform a Merkle proof as follows
i. Obtain the Merkle root R from a trusted source.
ii. Obtain the Merkle proof Γ from a source. In this case, Γ is the set of hashes:

Γ={N(1,1),N(2,3),N(4,7)}.
iii. Compute a Merkle proof using D₁ and Γ as follows:
   a. Hash the data block to obtain:

N(0,0)=H(D₀).
b. Concatenate with N(1,1) and hash to obtain:

N(0,1)=H(N(0,0)|N(1,1)).
c. Concatenate with N(2,3) and hash to obtain:

N(0,3)=H(N(0,1)|N(2,3)).
d. Concatenate with N(4,7) and hash to obtain the root:

N(0,7)=H(N(0,3)∥N(4,7)),

R′=N(0,7).
e. Compare the calculated root R′ with the root R obtained in (i):
   1. If R′=R, the existence of D₀ in the tree and therefore the data set [symbol] is confirmed.
   2. If R′ #R, the proof has failed and D₀ is not confirmed to be a member of [symbol] .

This is an efficient mechanism for providing a proof of existence for some data as part of the data set represented by a Merkle tree and its root. For example, if the data D₀ corresponded to a blockchain transaction and the root R is publicly available as part of a block header then we can quickly prove that the transaction was included in that block.

The process of authenticating the existence of D₀ as part of our example Merkle tree is shown in FIG. 6. This demonstrates that performing the Merkle proof for a given block D₀ and root R is effectively traversing the Merkle tree ‘upwards’ by using only the minimum number of hash values necessary.

### Minimum Information to Construct the Merkle Proof

When constructing a Merkle proof of a single leaf, the minimal information required is
1. Index of the leaf: the position of the leaf in the leaf layer in the Merkle tree.
2. An ordered list of hash values: the hash values required to calculate the Merkle root.

To explain how the index of the leaf works, consider the Merkle tree in FIG. 5. Bob knows the root R but does not know all the leaves of the Tree. The Merkle branch for D₀ consists of one index, 0, and three hash values (circled). The index is to indicate whether the provided hash value should be concatenated to the left or to the right of the calculated hash value.

Assume that a Merkle tree has N=2^{M} leaves. Given an index i at layer 0, let i₀=i, b₀=i₀ mod 2, p₀=i₀+(−1)^{b}^{₀}, i.e

$${p}_{0} = \{ \begin{matrix}{i}_{0} + 1 & {i}_{0} is even \\ {i}_{0} - 1 & {i}_{0} is odd\end{matrix}$$

p₀ is the index of the pair leaf node of the leaf node with index i₀. These are referred to as pairs since they are concatenated and hashed to calculate their parent hash node in the Merkle Tree (see above). The node with index p₀ is also referred to as “the provided hash” or “the required data” since it must be provided when calculating the Merkle root of the i₀ leaf node.

Thus, we can define at layer m, we have

$${i}_{m} = \frac{{i}_{m - 1} - {b}_{m - 1}}{2}$$

$${b}_{m} = {i}_{m} mod 2$$

Then the index of the provided hash is

$${p}_{m} = {i}_{m} + {( - 1 )}^{{b}_{m}}$$

The above equations assume that the index starts at 0.

### Signature Tree

Signature trees are an efficient alternative for a threshold signature requirement, where a threshold number of parties are required to sign a transaction. In this method, a Merkle tree is created, where each of its leaves can represent one spending condition. The locking script includes the root of the Merkle tree and opcodes to verify the Merkle proof. The unlocking script includes the Merkle proof and one of the spending conditions (i.e. one of the leaf nodes or information from which the leaf node can be derived).

Referring to the Merkle tree of FIG. 5, the leaf nodes Dₙ are derived from the public keys of the possible signers.

1-of-N Multisig

In a 1-of-N multisignature equivalent Merkle tree, the locking script generation steps are:
1. compute the hash of the public keys involved and put the hashes as the leaves of the tree, i.e., for example User 1 has public key P₁, let X₁=Hash (P₁);
2. compute the Merkle root; and
3. form the following Locking script:
   OP_6 OP_PICK SHA256 (OP_SWAP OP_IF OP_SWAP OP_ENDIF OP_CAT OP_SHA256)*3<Root> OP_EQUALVERIFY OP_CHECKSIG

Where the string (OP_SWAP OP_IF OP_SWAP OP_ENDIF OP_CAT OP_SHA256)*3 means that the opcodes between brackets are repeated [log 2 number of leaves]=3 number of times.

The unlocking script consists of: signature, public key and the Merkle proof.

The Merkle proof consists of <sibling_node><0 if sibling is to the left and 1 if it is to the right>

For example for User 5, with Public key Pₛ being data item D₄ of the Merkle tree of FIG. 5, would provide the following unlocking script:
<Sig><PK><N(0,3)><0><N(6,7)><1><N(5,5)><1>

The script execution is as follows:

| Main Stack | Script |
|---|---|
| | <Sig><PK><N(0, 3)><0><N(6, |
| | 7)><1><N(5, 5)><1> |
| | OP_6 OP_PICK SHA256 (OP_SWAP |
| | OP_IF OP_SWAP OP_ENDIF OP_CAT |
| | OP_SHA256)*3 |
| | <Root> OP_EQUALVERIFY |
| | OP_CHECKSIG |
| <Sig><PK₅><N(0, 3)><0><N(6, | OP_6 OP_PICK SHA256 (OP_SWAP |
| 7)><1><N(5, 5)><1> | OP_IF OP_SWAP OP_ENDIF OP_CAT |
| | OP_SHA256)*3 |
| | <Root> OP_EQUALVERIFY |
| | OP_CHECKSIG |
| <Sig><PK₅><N(0, 3)><0><N(6, | SHA256 (OP_SWAP OP_IF OP_SWAP |
| 7)><1><N(5, 5)><1><PK₅> | OP_ENDIF OP_CAT OP_SHA256)*3 |
| | <Root> OP_EQUALVERIFY |
| | OP_CHECKSIG |
| <Sig><PK₅><N(0, 3)><0><N(6, | (OP_SWAP OP_IF OP_SWAP |
| 7)><1><N(5, 5)><1> | OP_ENDIF OP_CAT OP_SHA256)*3 |
| <N(4, 4)> | <Root> OP_EQUALVERIFY |
| | OP_CHECKSIG |
| <Sig><PK₅> | (OP_SWAP OP_IF OP_SWAP |
| <N(0, 3)><0><N(6, | OP_ENDIF OP_CAT OP_SHA256)*2 |
| 7)><1><N(4, 5)> | <Root> OP_EQUALVERIFY |
| | OP_CHECKSIG |
| <Sig><PK₅> <N(0, | (OP_SWAP OP_IF OP_SWAP |
| 3)><0><N(4, 7)> | OP_ENDIF OP_CAT OP_SHA256)*1 |
| | <Root> OP_EQUALVERIFY |
| | OP_CHECKSIG |
| <Sig><PK₅> <Root_{calculated}> | <Root> OP_EQUALVERIFY |
| | OP_CHECKSIG |

We pass to the following stage if the hash of
the calculated Root equals the value in the L.S

| | |
|---|---|
| <Sig><PK₅>. | OP_CHECKSIG |

<True if the correct message is signed with the
secret key that corresponds to the public key>

### Merkle Proof Construct

Herein, [Merkle Root Derivation] is used as an abbreviation for: (OP_SWAP OP_IF OP_SWAP OP_ENDIF OP_CAT OP_SHA256) repeated t times, where t is the length of the Merkel proof and given by t=┌log₂ Number of leaves┐.

Each time, the string causes two sibling tree nodes to be concatenated and the hash of the concatenation to be calculated, the hash being the parent node of the two sibling tree nodes.
[Merkle Root Derivation] <Merkle Tree point A><0 if A is left, or 1 otherwise><Merkle Tree point>→<Parent node>

To illustrate, the execution of this part of the string is as follows:

| Main stack | [Merkle Root Derivation] |
|---|---|
| <N(5, 5)><1><N(4, 4)> | OP_SWAP OP_IF OP_SWAP OP_ENDIF OP_CAT |
| | OP SHA256 |
| <N(5, 5)><N(4, 4)><1> | OP_IF OP_SWAP OP_ENDIF OP_CAT OP_SHA256 |
| <N(5, 5)><N(4, 4)> | OP_SWAP OP_ENDIF OP_CAT OP_SHA256 |
| <N(4, 4)><N(5, 5)> | OP_CAT OP_SHA256 |
| <N(4, 4)\|N(5, 5)> | OP_SHA256 |
| <N(4, 5)> | |

### M-of-N Multisig

The above method can be used to allow a threshold of M signers out of N. In that case, each leaf corresponds to one of the M-of-N combinations (i.e. N choose M).

For example, if there are five users {U₁, U₂, U₃, U₄, U₅} and there is a requirement for 4 of the 5 users to sign, i.e. 4-of-5 multisig, a tree is constructed with leaves Xᵢ given by:

X₁→U₁,U₂,U₃,U₄

X₂→U₁,U₂,U₃,U₅

X₃→U₁,U₂,U₄,U₅

X₄→U₁,U₃,U₄,U₅

X₅→U₂,U₃,U₄,U₅

Since there are an odd number of leaves, a “dummy” leaf X₆ is introduced so that there is an even number of leaves. The dummy leaf may have a value of 1, some other pre-defined constant, or the value of its sibling leaf (i.e. setting X₆:=X₅).

The locking script would include the root of the tree. The unlocking script would need to provide the Merkle proof that proves the link to the root.

### In-Script Elliptic Curve Point Addition Checking

In-script elliptic curve point addition checking (IECPAC) provides a method for checking that P₁+P₂=P₃ in the script, where Pᵢ=(xᵢ, yᵢ) is an elliptic curve (EC) point. It establishes a function:

<Point Add P₁,P₂,λ,P₃>

that takes P₁, P₂, λ, P₃ as its inputs and returns TRUE if λ is the gradient of the line between P₁ and P₂, and if P₃=P₁+P₂. These two verifications are done in script.

The function comprises two steps
1. The value of λ is verified by checking that in the case P₁+P₂:

$$λ ( {x}_{2} - {x}_{1} ) mod p = {y}_{2} - {y}_{1} mod p$$

or in the case P₁=P₂:

$$λ {y}_{1} p = 3 {x}_{1}^{2} p$$

2. The value of P₃ is validated by checking that the coordinates of P₃=(x₃, y₃) satisfy:

$${x}_{3} = {λ}^{2} - {x}_{1} - {x}_{2} mod p$$

$${y}_{3} = λ ( {x}_{1} - {x}_{3} ) - {y}_{1} mod p$$

This method can be extended to an arbitrary number of points. For example, to verify the addition of three EC-points P=P₁+P₂+P₃, the operations are:

<Point Add Multi P₁,P₂,P₃,Δ′,Δ,P>:=<Point Add P₁,P₂,Δ′,P′><Point Add P′,P₃,Δ,P>

Where P′=P₁+P₂, the value Δ′ is the gradient between P₁ and P₂, and the value λ is the gradient between P′ and P₃.

P₁, P₂, P₃ and Δ can be provide in the unlocking script and the check preformed in script.

### R-Puzzle by Merkle Tree

According to the embodiments of the present disclosure, the concepts of R-puzzles and signature trees may be advantageously combined to provide a flexible and secure way of locking an output of a blockchain transaction. A first user (e.g. Alice 103a) constructs a first transaction that includes a locking script that locks an output of the first transaction. The locking script is configured to require an unlocking script of a second transaction, generated by a second user (e.g. Bob 103b) or group of users, to comprise a Merkle proof portion, a signature portion, and a public key. In order to successfully unlock the locking script, the signature portion must include an r-portion, which when hashed produces a hash value that forms part of a Merkle tree. The locking script performs a Merkle proof using the hash value and the Merkle proof, and verifies that it matches a node (or portion) of the Merkle tree that is included in the locking script (test 1). For instance, the node may be the Merkle root of the Merkle tree. In addition, the signature portion is validated using the public key (test 2). Only if each test is met will the locking script and unlocking script successfully execute.

Each of a set of users knows a secret value k. A Merkle tree is defined with the nodes being based on the r or R values (or “r-portions”) derived from the secret values of the users. As set out above:

r=[R]ₓ mod n

R=kG

where the ECDSA signature takes the form (r, s).

The term “r-portion” is used herein to refer to both R and r, with r being the r-part of the ECDSA signature.

Note that whilst reference herein is made to ECDSA signatures, it should be appreciated that ECDSA is just one type of digital signature scheme, and in general any equivalent scheme may be used.

1-of-N R-Values

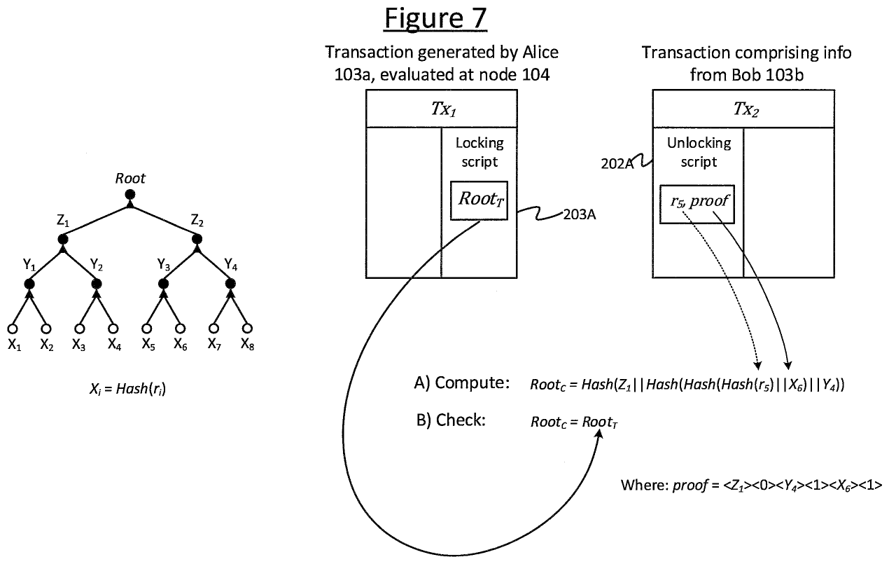

FIG. 7 shows an example Merkle tree, first transaction Tx₁, and second transaction Tx₂ for implementing a system in which 1 of N users is required to unlock a locking script 203A of the first transaction Tx₁, generated by a first user 103a.

In this case, each user Uᵢ has a secret kᵢ. Each leaf node of the Merkle tree is the hash of the r-part derived from the secret value kᵢ of one of the users.

The following steps are implemented:
1. Calculate Rᵢ=kᵢG=(xᵢ, yᵢ)
2. Get rᵢ=xᵢ mod N
3. Calculate the leaf value Xᵢ=Hash (rᵢ)
4. Share Xᵢ with the rest of the users or a coordinator so that the Merkle tree can be constructed
5. Calculate the Merkle root Root of the tree from leaves Xᵢ.

Since rᵢ cannot be derived from Xᵢ, sharing Xᵢ with the other users does not affect security.

The Merkle root is also referred to as a “Merkle tree portion”. Similarly, a leaf node or intermediate node of the Merkle tree may also be referred to as a Merkle tree portion.

The locking script may take the following form:
<2t+1> OP_PICK [Extract_r] SHA_256 [Merkle Root Derivation]<Root> OP_EQUALVERIFY OP_CHECKSIG

Where t=┌log₂(Number of leaves)┐.

The unlocking script may be in the form:
<Sig><PK><Merkle Proof>

That is, the unlocking script comprise a signature of the form (rᵢ, sᵢ), where rᵢ is the r-portion of the locking script, a public key PK of the signer, and a Merkle proof portion.

The unlocking script 202A is provided in the second transaction Tx₂, generated by a second user 103b. In the example of FIG. 7, user 5 generates the unlocking script 202A. In this instance, the Merkle proof is <Z₁><0><Y₄><1><X₆><1>.

When executed together with the unlocking script 202A, the unlocking script 203A causes the following steps to be implemented:
1. The r-part of the signature is extracted from the unlocking script 202A;
2. The r-part is hashed;
3. A candidate Merkle tree root is generated using the extracted r-part and the Merkle proof of the unlocking script 202A (step A);
4. The candidate Merkle proof is verified by checking that it is equal to the Merkle root provided in the locking script 203A (the target Merkle root); and
5. The signature is verified using the public key provided in the unlocking script 202A.

The unlocking script is valid for any <Sig><PK> provided as long as the following conditions are all true:
1. The Hash of the extracted r value from the signature matches one of the tree leaves;
2. The Merkle proof provided calculates a root that matches the value in the locking script; and
3. The pair <Sig><PK> is validated by OP_CHECKSIG.

### M-of-N R-Values

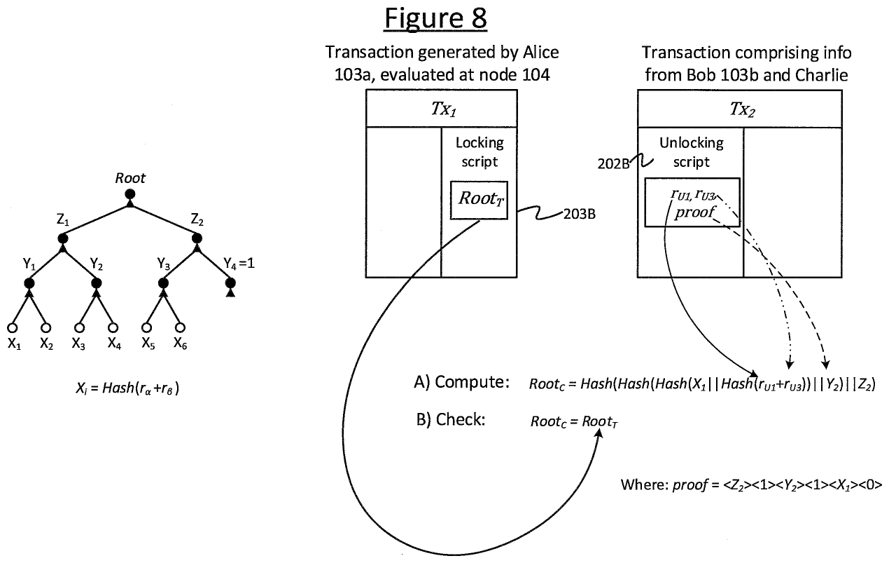

FIG. 8 shows an example Merkle tree, first transaction Tx₁, and second transaction Tx₂ for implementing a system in which M of N users are required to unlock a locking script 203B of the first transaction Tx₁, generated by a first user 103a.

Again, each user Uᵢ has a secret kᵢ. However, in this case, each leaf node of the Merkle tree is the hash of a combination of the r-parts derived from the secret value kᵢ of a group of users who together can unlock the locking script 202B.

In 2-of-4 system, each leaf Xᵢ corresponds to one of 6 possible 4-choose-2 combinations

$${X}_{1} \to {U}_{1} , {U}_{2} \to {X}_{1} = Hash ( {r}_{U 1} + {r}_{U 2} )$$

$${X}_{2} \to {U}_{1} , {U}_{3} \to {X}_{2} = Hash ( {r}_{U 1} + {r}_{U 3} )$$

$${X}_{3} \to {U}_{1} , {U}_{4} \to {X}_{3} = Hash ( {r}_{U 1} + {r}_{U 4} )$$

$${X}_{4} \to {U}_{2} , {U}_{3} \to {X}_{4} = Hash ( {r}_{U 2} + {r}_{U 3} )$$

$${X}_{5} \to {U}_{2} , {U}_{4} \to {X}_{5} = Hash ( {r}_{U 2} + {r}_{U 4} )$$

$${X}_{6} \to {U}_{3} , {U}_{4} \to {X}_{6} = Hash ( {r}_{U 3} + {r}_{U 4} )$$

The corresponding Merkle tree has 6 leaves. That is, there is no X₇ or X₈. In order to balance the tree, Y₄, which has no leaf nodes, is set to 1. Y₄ is referred to as a “dummy” node. If instead there were an odd number of leaf nodes, the dummy node would be a dummy leaf node, also equal to 1.

While the r_{Ui} values above are summed, it will be appreciated that these values may be combined in any other way, for example by concatenating or multiplying the r-part of each user in the group.

The Locking script may include 2 r-extractors, a single Merkle proof, and 2 OP_CHECKSIG:
OP_7 OP_PICK [Extract_r] OP_10 OP_PICK [Extract_r] OP_ADD OP_SHA256 [Merkle Root Derivation]<Root>OP_EQUALVERIFY OP_CHECKSIG OP_CHECKSIG

The unlocking script comprises two <Sig><PK> and one Merkle proof:
<Sig₁><PK₁><Sig₂><PK₂><Merkle Proof>

That is, the unlocking script 202B comprises a signature-key pair for each of the users, each signature comprising an r-part, and the Merkle proof portion.

The script execution for X₆, where U₃ uses k₃ to calculate r₃ and provides <Sig_{U3}><PK_{U3}>, and U₄ similarly uses k₄ and provides <Sig_{U4}><PK_{U4}> is as follows:

| Main Stack | Script |
|---|---|
| <Sig_{U3}><P_{U3}><Sig_{U4}><P_{U4}><Z₁><0> | OP_7 OP_PICK [Extract_r] OP_10 |
| <Y₄><1><X₅><0> | OP_PICK [Extract_r] OP_ADD |
| | OP_SHA256 [Merkle Root Derivation] |
| | <Root> OP_EQUALVERIFY |
| | OP_CHECKSIG OP_CHECKSIG |
| <Sig_{U3}><P_{U3}><Sig_{U4}><P_{U4}><Z₁><0> | [Extract_r] OP_10 OP_PICK [Extract_r] |
| <Y₄><1><X₅><0><Sig_{U4}> | OP_ADD OP_SHA256 [Merkle Root |
| | Derivation] <Root> OP_EQUALVERIFY |
| | OP_CHECKSIG OP_CHECKSIG |
| <Sig_{U3}><P_{U3}><Sig_{U4}><P_{U4}><Z₁><0> | OP_10 OP_PICK [Extract_r] OP_ADD |
| <Y₄><1><X₅><0><r_{U4}> | OP_SHA256 [Merkle Root Derivation] |
| | <Root> OP_EQUALVERIFY |
| | OP_CHECKSIG OP_CHECKSIG |
| <Sig_{U3}><P_{U3}><Sig_{U4}><P_{U4}><Z₁><0> | [Extract_r] OP_ADD OP_SHA256 |
| <Y₄><1><X₅><0><r_{U4}><Sig_{U3}> | [Merkle Root Derivation] <Root> |
| | OP_EQUALVERIFY OP_CHECKSIG |
| | OP_CHECKSIG |
| <Sig_{U3}><P_{U3}><Sig_{U4}><P_{U4}><Z₁><0> | OP_ADD OP_SHA256 [Merkle Root |
| <Y₄><1><X₅><0><r_{U4}><r_{U3}> | Derivation] <Root> OP_EQUALVERIFY |
| | OP_CHECKSIG OP_CHECKSIG |
| <Sig_{U3}><P_{U3}><Sig_{U4}><P_{U4}><Z₁><0> | [Merkle Root Derivation] <Root> |
| <Y₄><1><X₅><0><Hash(r_{U3} + r_{U4}) | OP_EQUALVERIFY OP_CHECKSIG |
| | OP_CHECKSIG |
| <Sig_{U3}><P_{U3}><Sig_{U4}><P_{U4}><Root_{calculated}> | <Root> OP_EQUALVERIFY |
| | OP_CHECKSIG OP_CHECKSIG |

We get to the next stage if Root_{calculated} is
the same as the one in the Locking script

| | |
|---|---|
| <Sig_{U3}><P_{U3}><Sig_{U4}><P_{U4}> | OP_CHECKSIG OP_CHECKSIG |

True if both signatures are correct

Referring to FIG. 8, two users, U₁ and U₃, generate the second transaction comprising the unlocking script 202B. The combination r_{U1}+r_{U3} corresponds to leaf node X₂, such that the provide Merkle proof is <Z₂><1><Y₂><1><X₁><0>.

When the locking script 203B is executed together with the unlocking script 202B, the following steps are implemented:
1. The r-part of the each of the signature is extracted from the unlocking script 202B;
2. The two r-parts are summed and the summation is hashed;
3. The candidate Merkle tree root is generated using the extracted r-parts and the Merkle proof of the unlocking script 202B (step A);
4. The candidate Merkle proof is verified by checking that it is equal to the target Merkle root provided in the locking script 203B; and
5. Each of the signatures is verified using its corresponding public key provided in the unlocking script 202B.

The unlocking script is valid for any <Sig><PK> provided as long as the following conditions are all true:
1. The Hash of the combination of the extracted r value from the signature matches one of the tree leaves;
2. The Merkle proof provided calculates a root that matches the value in the locking script; and
3. Both signature-key pairs <Sig><PK> are validated by OP_CHECKSIG.

The above method can be extended to any M-of-N, such that the locking script may be given by:
<2t+1> OP_PICK [Extract_r]<2t+4> OP_PICK [Extract_r] OP_ADD OP_SHA256 [Merkle Root Derivation <Root> OP_EQUALVERIFY OP_CHECKSIG*M

Where t is the length of the Merkle proof,

$$t = ⌈ {log}_{2} Number of leaves ⌉ = ⌈ {log}_{2} ( \begin{matrix}N \\ M\end{matrix} ) ⌉ ,$$

is the threshold, i.e. number of required signers, and OP_CHECKSIG*M means repeating OP_CHECKSIG M-times.

The use of the Merkle tree set out above in which the leaf nodes are the hash of a combination of the M r values is a more efficient solution for M-of-N signature requirements. This is because the locking and unlocking script are smaller than for the alternative solution to the M-of-N system in which there are M distinct paths for M signers, with each leaf corresponds to a single user, such that the Merkle tree would have N leaves.

In the case of M distinct paths, the unlocking script contains M Merkle proofs, where a single Merkle proof is of length ┌log₂ N┐ nodes.

However, if each leaf node is set to correspond to one of the N-choose-M possibilities, the tree has

$$( \begin{matrix}N \\ M\end{matrix} )$$

leaves, and the unlocking script contains a single Merkle proof of

$$⌈ {log}_{2} ( \begin{matrix}N \\ M\end{matrix} ) ⌉$$

nodes.

There will always be

$$⌈ {log}_{2} ( \begin{matrix}N \\ M\end{matrix} ) ⌉ < M \times ⌈ {log}_{2} N ⌉$$

for all positive integers N and M where M≤N.

Therefore, the use of the M-of-N tree set out above is less expensive and more efficient since the size, and therefore the cost, of the tree and scripts are reduced.

The method proposed above requires repeating OP_CHECKSIG M times. To remove this requirement, each group of users (corresponding to a leaf in the Merkle tree) have a single signing key. This reduces the number of OP_CHECKSIG opcodes to one, and reduces the size of the unlocking script. This reduces cost and improves efficiency as both the unlocking and locking scripts are shorter, and their execution has fewer steps.

### R Points Elliptical Curve Addition

The signature tree comprising r-puzzle leaf nodes can be modified such that EC point addition is used to generate the leaves. IECPAC is then used to check that an EC-point, R_{X}_{ᵢ}, extracted from the unlocking script is actually a sum of M EC-points, R₁, . . . , R_{M}, also extracted from the unlocking script. Once the IECPAC checks have been performed, the link of R_{X}_{ᵢ} to a Tree leaf and subsequently the link to Root value provided in the locking script is validated using Merkle proof derivation.

As in the previous section, a Merkle tree is formed, where each of the leaves corresponds to each of the possible N-choose-M combinations.

The use of the IEPCA method provides a technique for proving that the user knows both the leaf data (i.e. the summation R-value) and the R-values (or r-portions) from which the leaf data is derived (i.e. the R-values of the M users).

### Individual Signature Scheme

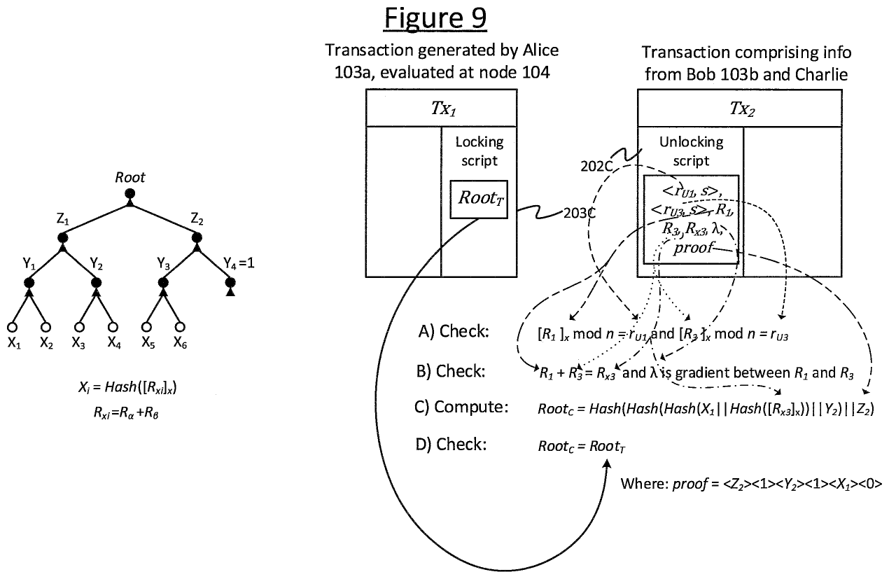

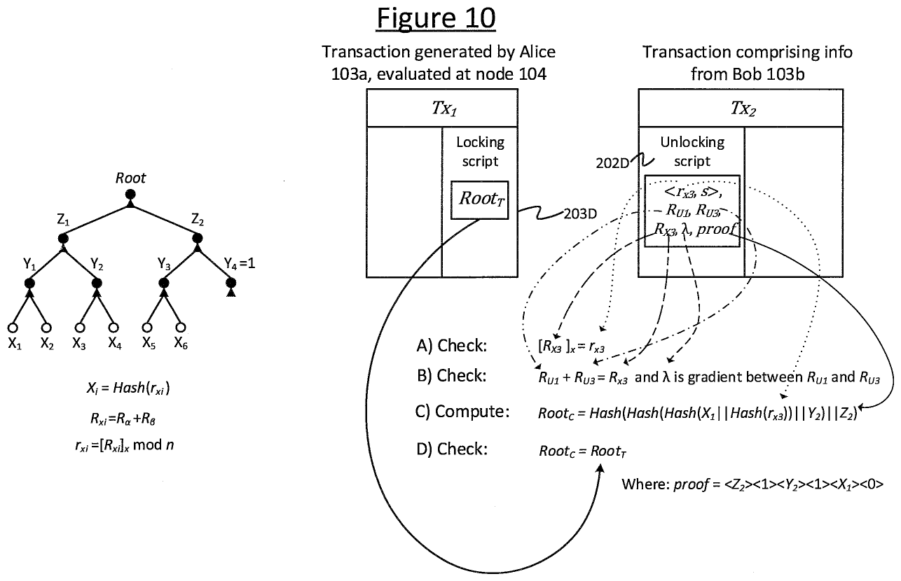

FIG. 9 shows an example Merkle tree, first transaction Tx₁, and second transaction Tx₂ for implementing a system in which M of N users are required to unlock a locking script 203C of the first transaction Tx₁, generated by a first user 103a.

Again, each user Uᵢ has a secret kᵢ. Each leaf node of the Merkle tree is the hash of an x-coordinate derived from a sum of the M r-values derived from the secret value kᵢ of a group of users who together can unlock the locking script 202C. That is, for M=2,

$${X}_{i} = ( {[ {R}_{{X}_{i}} ]}_{x} ) ,$$

where R_{X}_{ᵢ}=R_{α}+R_{β}.

A 2-of-4 multi-sig system is provided as an example. Each leaf Xᵢ of the Merkle tree corresponds to one of 6 possible 4-choose-2 combinations of users, as in the example of FIG. 8, who may unlock the locking script 203C. For example, leaf X₁ is generated by users U₁ and U₂. Y₄ is again set to 1 to balance the Merkle tree.

In an individual signature scheme, each group member provides their own signature.

The following steps are implemented:
1. Each Uᵢ has a secret value kᵢ
2. Calculate Rᵢ=kᵢG=(xᵢ, yᵢ)
3. Add the elliptic curve points to get R_{X}_{₁}=R₁+R₂=(x_{X}_{₁}, y_{X}_{₁})
4. X₁=hash (x_{X}_{₁})

Each of the N-choose-M groups share their Xᵢ with either the other users or a coordinator in order to construct the Merkle tree.

While the Merkle tree itself is similar to that shown in FIG. 8, the locking script 203C and unlocking script 202C comprise additional components used for IECPAC.

The locking script 203C contains:
1. the root of the tree,
2. two OP_CHECKSIG opcodes,
3. two Extract_r opcode strings,
4. opcodes string for IECPAC,
5. Merkle Root derivation opcode strings.

The second transaction is provided by users 1 and 3, corresponding to leaf node X₃. The unlocking script 202C comprises:
1. 2 signatures and 2 public keys, each pair corresponding to one of the users: <r₁, s₁><PK₁><r₃, s₃><PK₃>
2. the elliptic curve points <R₁, R₃, R_{X}_{₃}>
3. the gradient between two EC points R₁, R₃, <λ_{R}_{₁}_{R}_{₃}>
4. <Merkle Proof>.

The gradient <λ_{R}_{₁}_{R}_{₂}> is used by the IECPAC to verify R₁+R₃=R_{X}_{₃}.

The Merkle tree may be constructed using either R or r for each of the users. In the example of FIG. 9, each Xᵢ is the hash of the summation R (or x co-ordinate thereof), e.g. R₁+R₃=R_{X}_{₃}=(x_{X}_{₃}, y_{X}_{₃}) and X₃=hash (x_{X}_{₃}), the leaf pre-image would be R_{X}_{₃}. That is, the leaf pre-image included in the unlocking script 202C is dependent on which type of r-portion the leaf nodes are derived from.

When the locking script 203C is executed together with the unlocking script 202C, the following steps occur:
1. r_{U1} and r_{U3} are extracted from the signatures;
2. r₁ and r₃ are extracted from R₁, R₃ using rᵢ=xᵢmod n. The extracted rᵢ are checked if they match r_{U}_{ᵢ} (step A);
3. Check that R₁+R₃=R_{X}_{₃} using the IECPAC algorithm as set out above (step B);
4. X₃ is calculated using X₃=hash (x_{X}_{₃}), where x_{X}_{₃}=[R_{X}_{₃}]ₓ;
5. The candidate Merkle Root is calculated from <Merkle Proof> and X₃ (step C);
6. The candidate Merkle root is checked if it is equal to the target Merkle root provided in the locking script (step D); and
7. The 2 signatures are independently validated.

The value x_{X}_{₃} used to calculate X_{U3} is extracted from R_{X}_{₃}, which is included in the unlocking script.

In the general case of M>2, the locking script contains M OP_CHECKSIG opcodes, M Extract_r opcode strings, (M−1) IECPAC strings, and a single Merkle Root derivation opcodes string.

The unlocking script contains M signatures and public keys, (M−1) gradient values <λ₁> . . . <λ_{M-1}> and M−EC points Rᵢ, M−2 intermediate EC-points and the EC-point R_{X}_{ⱼ} that is the sum of all M points to run the IECPAC, and a single Merkle proof.

### Single Signature Per Group

In order to reduce the length of both the locking and unlocking scripts, and subsequently the execution time, the method of FIG. 9 can be adapted such that each group of users shares a single signature.

In this case each of the N-choose-M groups choose a single R-puzzle to represent the group. The IECPAC is used to prove to an outside observer that the provided signature is generated from multiple users. This embodiment assumes a high trust level between members of each group, since any group member can provide the signature and modify the transaction.

FIG. 10 shows an example implementation of the single signature embodiment using IECPAC. As before, there are four individual users in the 2-of-4 system, with each user having their own secret value kᵢ.

The Merkle tree has

$$( \begin{matrix}M \\ N\end{matrix} )$$

leaves

$${X}_{1} … {X}_{( \begin{matrix}M \\ N\end{matrix} )} ,$$

and constructed as follows:
1. Each group member calculates Rᵢ=kᵢG and share it with rest of the group
2. EC-point addition is calculated R_{X}_{ᵢ}=(x_{X}_{ᵢ}, y_{X}_{ᵢ})=R₁+R₂+ . . . +R_{M}
3. A leaf is given by Xᵢ=hash (x_{X}_{ᵢ})

In the example of FIG. 10, there are therefore 6 leaves, each being derived from the sum of the R value of the two users of the signatory group associated with the leaf node.

The locking script 203D contains:
1. a single OP_CHECKSIG opcode,
2. a single Extract_r opcodes string,
3. string opcodes to run IECPAC (M−1) times,
4. a single Merkle Root derivation opcodes string, and
5. A Merkle root.

The unlocking script 202D is provided by a single one of the users of the group, either U₁ or U₃, and contains:
1. a single signature (r_{X}_{₃}, S_{X}_{₃}) and the corresponding public key,
2. <λₓ_{₃}> gradient value,
3. <R₁>, <R₃>,
4. a Merkle proof, and
5. R_{X}_{₃}.

Generally for any M-of-N group, the unlocking script is:
1. a single signature (r_{X}_{ᵢ}, S_{X}_{ᵢ}) and the corresponding public key,
2. <λ₁> . . . <λ_{M-1}> gradient values,
3. <R₁> . . . <R_{M}>,
4. a Merkle proof, and
5. R_{X}_{ᵢ}

To be able to generate a signature (r_{X}_{ᵢ}, s_{X}_{ᵢ}), all group members share their secrets kᵢ. This is because the value k_{X}_{ᵢ} must be known to the signer to calculate s_{X}_{ᵢ}, where R_{X}_{ᵢ}=k_{X}_{ᵢ}G=(k₁+ . . . +k_{M})G.

When the locking script 203D is executed together with the unlocking scrip 202D, the following step are implemented:
1. rₓ₃ is extracted from the signature and is used to check [R_{X3}]ₓ mod n=rₓ₃ (step A),
2. along with R_{U1}, R_{U3}, and the gradient λ, to check that R_{U1}+R_{U3}=R_{X3} using IECPAC as set out above (step B),
3. X₃ is calculated using X₃=hash (x_{X}_{₃});
4. The candidate Merkle Root is calculated from <Merkle Proof> and X₃ (step C);
5. The candidate Merkle root is checked if it is equal to the target Merkle root provided in the locking script (step D); and
6. The signature is validated.

In the more general M-of-N embodiment, step 1 above uses all of the (M−1) gradients and M R-values provided in the unlocking script, the IEPAC method is run M−1 times, and M−2 intermediate EC-points are included.

The value Xᵢ may be calculated using rₓᵢ as extracted from the group signature as set out above, or it may be calculated from using the R-values provided in the unlocking script corresponding to each individual users of the group (R_{Ui}), i.e. X₃=hash ([R_{U1}+R_{U3}]ₓ).

Whether a single group signature or multiple individual signatures embodiment is used, the IECPAC complexity grows linear with M.

### Path Choice

In the examples set out above, the Merkle root is provided in the locking script and any user may provide the unlocking script, provided they know k and the Merkle proof, where k=k₁+k₂+ . . . +k_{M}.

To restrict the users who can provide unlocking scripts, the locking script creator may, instead, provide a node of the Merkle tree in the locking script. In this way, only users whose r-values are used to generate leaf nodes located below said node in the Merkle tree can be unlocking script creators.

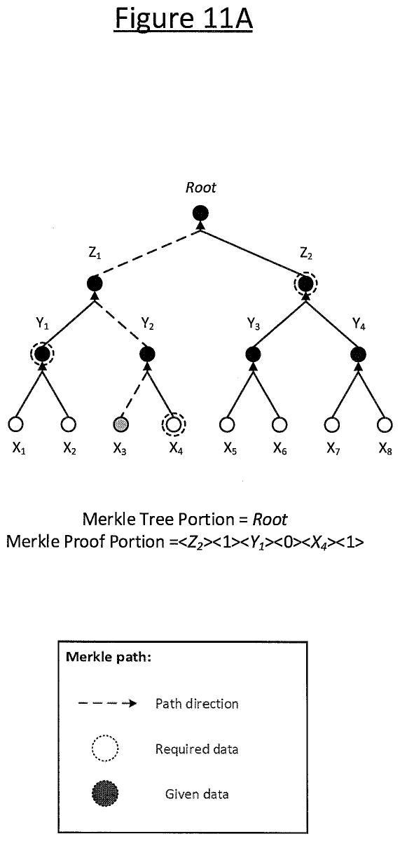

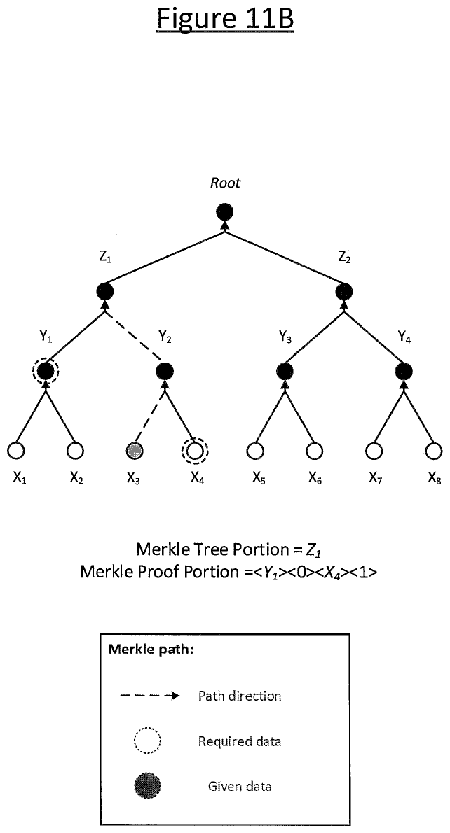

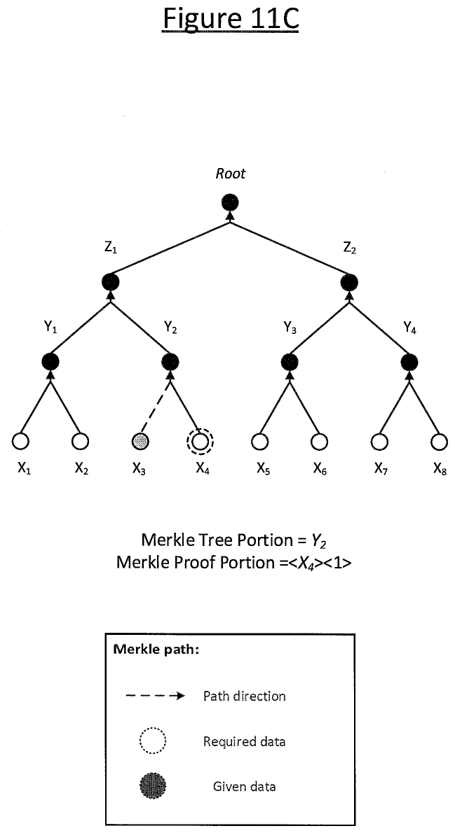

FIGS. 11A-C show Merkle trees comprising 8 leaf nodes, each Xᵢ being Hash (rᵢ), i.e. each node corresponds to a single user. Each of these figures shows the path along with the Merkle tree is traversed from the leaf node derived from the r-portion extracted from the unlocking script to the Merkle tree portion provided in the locking script, shows as a dashed line.

In each example, user 3 corresponding to X₃ provides the unlocking script, which comprises r₃ in the signature, as described above.

FIG. 11A shows an example in which the locking script contains the Merkle root Root such that any of the 8 users can unlock the locking script. Here, the Merkle proof comprises X₄, Y₁, and Z₂.

The following locking script can be unlocked by any of {U₁, . . . , U₈}:
OP_7 OP_PICK [Extract_r] SHA_256 [Merkle Root Derivation]<Root> OP_EQUALVERIFY OP_CHECKSIG

If instead the locking script comprises Z₁, as is shown in FIG. 11B for example, only users 1-4 can unlock the locking script. The Merkle proof portion provided in the unlocking script is shorter than that for if the locking script comprises the root by one level of the Merkle tree. That is, the Merkle proof portion of the unlocking script is shorter by two terms: <Z₂><1>.

In this case, the locking script is as follows:
OP_5 OP_PICK [Extract_r] SHA_256 [Merkle Root Derivation′]<Z₁> OP_EQUALVERIFY OP_CHECKSIG

Such that any of users {U₁, . . . , U₄} can provide the unlocking script.

The creator of the transaction can further limit the possible script unlockers to two by inserting, for example, Y₂ in the locking script as shown in FIG. 11C. Here, only users 3 and 4 can unlock the transaction.

In this case, the locking script may take the following form:
OP_5 OP_PICK [Extract_r] SHA_256 [Merkle Root Derivation″]<Y₂> OP_EQUALVERIFY OP_CHECKSIG

Note that [Merkle Root Derivation] in the first locking script derives the root from a 3-points Merkle proof, whereas [Merkle Root Derivation] in the 2^{nd} and 3^{rd} locking scripts require a 2-points and 1-point Merkle proof respectively. The number of points refers to the number of node values provided in the Merkle proof portion of the unlocking script, which is used to calculate the candidate Merkle proof.

The locking scripts of any of the above embodiments may be modified to provide a node of the Merkle tree rather than the Merkle root, and thus define a subset of users, or a subset of groups of users, who can create the unlocking script.

### Conclusion

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. According to a first aspect, there is provided a computer-implemented method of generating a blockchain transaction, wherein each party of a plurality of second parties has a respective secret number k from which a respective r-portion is derivable, wherein a Merkle tree is defined, at least one leaf node of the Merkle tree being based on at least one of the respective r-portions, wherein the method is performed by a first party and comprises:
generating a first blockchain transaction, wherein the first blockchain transaction comprises a first locking script comprising a target Merkle tree portion corresponding to the Merkle tree, the first locking script configured, when executed together with a first unlocking script of a second blockchain transaction, to:
   extract an r-portion from the first unlocking script,
   generate a hash value derived from the extracted r-portion,
   calculate a candidate Merkle tree portion based on the generated hash and a Merkle proof portion of the first unlocking script,
   verify that the calculated candidate Merkle tree portion matches the target Merkle tree portion,
   verify a signature portion of the first unlocking script based on a public key of the first unlocking script, and
making the first blockchain transaction available to one or more nodes of a blockchain network.

Statement 2. An embodiment of the method of statement 1, wherein the r-portion is extracted from an elliptical curve digital signature algorithm (ECDSA) signature of the signature portion of the first unlocking script, the r-portion being an r-part of the ECDSA signature.

Statement 3. An embodiment of the method of statement 2, wherein each leaf node of the Merkle tree is a hash of a combination of multiple r-portions, wherein the first locking script is configured to extract multiple r-portions from the first unlocking script and combine the multiple r-portions, wherein the hash value is a hash of the combined multiple r-portions.

Statement 4. An embodiment of the method of statement 3, wherein the r-portions are combined using one of addition and concatenation.

Statement 5. An embodiment of the method of statement 1, wherein the at least one leaf node of the Merkle tree is a hash of a sum of multiple r-portions, wherein the first locking script is configured to:
extract multiple r-portions from the first unlocking script, each of the multiple r-portions corresponding to one of the plurality of parties,
calculate a sum of the multiple extracted r-portions,
extract a summation r-portion from the first unlocking script, the summation r-portion being a sum of the multiple r-portions, and
validate the extracted multiple r-portions based on the calculated sum of the multiple extracted r-portions and the extracted summation r-portion,
wherein the multiple r-portions and the summation r-portion are elliptical curve points.

Statement 6. An embodiment of the method of statement 5, wherein the hash value is a hash of one of: the calculated sum of the multiple r-portions and the extracted summation r-portion.

Statement 7. An embodiment of the method of statement 5 or statement 6, wherein the first locking script is further configured to:
extract one or more gradient values from the first unlocking script; and
verify, based on the extracted one or more gradient values and the multiple extracted r-portions, that each of the extracted one or more gradient values is equal to the gradient between two of the multiple extracted r-portions.

Statement 8. An embodiment of the method of statement 7, wherein the number of gradient values is one less than the number of extracted multiple r-portions corresponding to one of the secret numbers k.

Statement 9. An embodiment of the method of any of statements 3 to 8, wherein the first locking script is configured to verify each of multiple signature portions of the first unlocking script, each of the multiple signature portions provided with a corresponding public key, the verification of each of the multiple signature portions being based on the provided corresponding public key.

Statement 10. An embodiment of the method of statement 9, wherein the corresponding public keys are provided in the first unlocking script.

Statement 11. An embodiment of the method of any of statement 5 to 8 when dependent on claim 1, wherein the summation r-portion is extracted from a signature portion of the unlocking script.

Statement 12. An embodiment of the method of statement 1 or statement 2, wherein the at least one leaf node of the Merkle tree is a hash of a combination of multiple r-portions, wherein the extracted r-portion is equal to the combination of multiple r-portions of the leaf node corresponding to the Merkle tree portion of the first locking script.

Statement 13. An embodiment of the method of any preceding statement, wherein the Merkle tree portion is a Merkle root of the Merkle tree.

Statement 14. An embodiment of the method of any of statements 1 to 10, wherein the Merkle tree portion is a node of the Merkle tree other than the Merkle root.

Statement 15. An embodiment of the method of statement 1 or any of statements 5 to 14 when dependent on statement 1, wherein the r-portion is an elliptical curve point.

Statement 16. According to a second aspect, there is provided a computer-implemented method of generating a blockchain transaction, wherein each party of a plurality of second parties has a secret number k from which an r-portion is derivable, wherein a Merkle tree is defined, at least one leaf node of the Merkle tree being based on at least one of the respective r-portions, wherein a first blockchain transaction comprises a first locking script comprising a target Merkle tree portion corresponding to the Merkle tree, the first locking script configured, when executed together with a first unlocking script of a second blockchain transaction, to extract an r-portion from the first unlocking script, generate a hash value derived from the extracted r-portion, calculate a candidate Merkle tree portion based on the generated hash and a Merkle proof portion of the first unlocking script, verify that the calculated candidate Merkle tree portion matches the target Merkle tree portion of the first locking script, and verify a signature portion of the first unlocking script based on a public key of the first unlocking script, wherein the method is performed by at least one of said second parties and comprises:
generating the second blockchain transaction, the second blockchain transaction comprising an input referencing the first locking script of the first blockchain transaction and the first unlocking script, the first unlocking script comprising the Merkle proof portion, the signature portion, and the public key; and
making the second blockchain transaction available to one or more nodes of a blockchain network.

Statement 17. An embodiment of the method of statement 16, wherein the signature portion comprises an elliptical curve digital signature algorithm (ECDSA) signature of the signature portion of the first unlocking script, the r-portion being an r-part of the ECDSA signature.

Statement 18. An embodiment of the method of statement 17, wherein the r-part is a combination of multiple r-portions derived from the secret number k of multiple of the plurality of second parties.

Statement 19. An embodiment of the method of statement 16, wherein the first unlocking script further comprises the r-portion.

Statement 20. An embodiment of the method of any of statements 15 to 18, wherein the first unlocking script further comprises one or more gradient values, the first locking script being configured to extract the one or more gradient values from the first unlocking script, and verify, based on the extracted one or more gradient values and multiple extracted r-portions extracted from the unlocking script, that each of the extracted one or more gradient values is equal to the gradient between two of the multiple extracted r-portions.

Statement 21. An embodiment of the method of statement 20, wherein the first unlocking script comprises a number of gradient values one less than a number of r-portions extracted from the unlocking script and corresponding to one of the multiple secret numbers k.

Statement 22. An embodiment of the method of any preceding statement, wherein the r-portion is derived from a public key corresponding to the secret number.

Statement 23. According to a third aspect, there is provided computer equipment comprising:
memory comprising one or more memory units; and
processing apparatus comprising one or more processing units, wherein the memory stores code arranged to run on the processing apparatus, the code being configured so as when on the processing apparatus to perform the method of any preceding claim.

Statement 24. According to a fourth aspect, there is provided a computer program embodied on computer-readable storage and configured so as, when run on one or more processors, to perform the method of any of claims 1 to 21.

1. A computer-implemented method of generating a blockchain transaction, wherein each party of a plurality of second parties has a respective secret number k from which a respective r-portion is derivable, wherein a Merkle tree is defined, at least one leaf node of the Merkle tree being based on at least one of the respective r-portions, wherein the method is performed by a first party and comprises:
generating a first blockchain transaction, wherein the first blockchain transaction comprises a first locking script comprising a target Merkle tree portion corresponding to the Merkle tree, the first locking script configured, when executed together with a first unlocking script of a second blockchain transaction, to:
extract an r-portion from the first unlocking script,
generate a hash value derived from the extracted r-portion,
calculate a candidate Merkle tree portion based on the generated hash and a Merkle proof portion of the first unlocking script,
verify that the calculated candidate Merkle tree portion matches the target Merkle tree portion,
verify a signature portion of the first unlocking script based on a public key of the first unlocking script, and
making the first blockchain transaction available to one or more nodes of a blockchain network.

2. The method of claim 1, wherein the r-portion is extracted from an elliptical curve digital signature algorithm (ECDSA) signature of the signature portion of the first unlocking script, the r-portion being an r-part of the ECDSA signature.

3. The method of claim 2, wherein each leaf node of the Merkle tree is a hash of a combination of multiple r-portions, wherein the first locking script is configured to extract multiple r-portions from the first unlocking script and combine the multiple r-portions, wherein the hash value is a hash of the combined multiple r-portions.

4. (canceled)

5. The method of claim 1, wherein the at least one leaf node of the Merkle tree is a hash of a sum of multiple r-portions, wherein the first locking script is configured to:
extract multiple r-portions from the first unlocking script, each of the multiple r-portions corresponding to one of the plurality of parties,
calculate a sum of the multiple extracted r-portions,
extract a summation r-portion from the first unlocking script, the summation r-portion being a sum of the multiple r-portions, and
validate the extracted multiple r-portions based on the calculated sum of the multiple extracted r-portions and the extracted summation r-portion,
wherein the multiple r-portions and the summation r-portion are elliptical curve points.

6. The method of claim 5, wherein the hash value is a hash of one of: the calculated sum of the multiple r-portions and the extracted summation r-portion.

7. The method of claim 5, wherein the first locking script is further configured to:
extract one or more gradient values from the first unlocking script; and
verify, based on the extracted one or more gradient values and the multiple extracted r-portions, that each of the extracted one or more gradient values is equal to the gradient between two of the multiple extracted r-portions.

8. The method of claim 7, wherein a number of gradient values of the one or more gradient values is one less than a number of extracted multiple r-portions corresponding to one of the secret numbers k.

9. The method of claim 3, wherein the first locking script is configured to verify each of multiple signature portions of the first unlocking script, each of the multiple signature portions provided with a corresponding public key, a verification of each of the multiple signature portions being based on the provided corresponding public key.

10. The method of claim 9, wherein the corresponding public keys are provided in the first unlocking script.

11. The method of claim 5, wherein the summation r-portion is extracted from a signature portion of the unlocking script.

12. The method of claim 1, wherein the at least one leaf node of the Merkle tree is a hash of a combination of multiple r-portions, wherein the extracted r-portion is equal to the combination of multiple r-portions of the leaf node corresponding to the Merkle tree portion of the first locking script.

13. The method of claim 1, wherein the Merkle tree portion is a Merkle root of the Merkle tree.

14. The method of claim 1, wherein the Merkle tree portion is a node of the Merkle tree other than a Merkle root of the Merkle tree.

15. (canceled)

16. A computer-implemented method of generating a blockchain transaction, wherein each party of a plurality of second parties has a secret number k from which an r-portion is derivable, wherein a Merkle tree is defined, at least one leaf node of the Merkle tree being based on at least one of the respective r-portions, wherein a first blockchain transaction comprises a first locking script comprising a target Merkle tree portion corresponding to the Merkle tree, the first locking script configured, when executed together with a first unlocking script of a second blockchain transaction, to extract an r-portion from the first unlocking script, generate a hash value derived from the extracted r-portion, calculate a candidate Merkle tree portion based on the generated hash and a Merkle proof portion of the first unlocking script, verify that the calculated candidate Merkle tree portion matches the target Merkle tree portion of the first locking script, and verify a signature portion of the first unlocking script based on a public key of the first unlocking script, wherein the method is performed by at least one of said second parties and comprises:
generating the second blockchain transaction, the second blockchain transaction comprising an input referencing the first locking script of the first blockchain transaction and the first unlocking script, the first unlocking script comprising the Merkle proof portion, the signature portion, and the public key; and
making the second blockchain transaction available to one or more nodes of a blockchain network.

17. The method of claim 16, wherein the signature portion comprises an elliptical curve digital signature algorithm (ECDSA) signature of the signature portion of the first unlocking script, the r-portion being an r-part of the ECDSA signature.

18. The method of claim 17, wherein the r-part is a combination of multiple r-portions derived from the secret number k of multiple of the plurality of second parties.

19. The method of claim 16, wherein the first unlocking script further comprises the r-portion.

20. The method of claim 16, wherein the first unlocking script further comprises one or more gradient values, the first locking script being configured to extract the one or more gradient values from the first unlocking script, and verify, based on the extracted one or more gradient values and multiple extracted r-portions extracted from the unlocking script, that each of the extracted one or more gradient values is equal to the gradient between two of the multiple extracted r-portions.

21. The method of claim 20, wherein the first unlocking script comprises a number of gradient values one less than a number of r-portions extracted from the unlocking script and corresponding to one of the multiple secret numbers k.

22-23. (canceled)

24. A computer program embodied on non-transitory computer-readable storage media and configured so as, when run on one or more processors, the one or more processors perform the method of:
generating a blockchain transaction, wherein each party of a plurality of second parties has a respective secret number k from which a respective r-portion is derivable, wherein a Merkle tree is defined, at least one leaf node of the Merkle tree being based on at least one of the respective I-portions, wherein the method is performed by a first party and comprises:
generating a first blockchain transaction, wherein the first blockchain transaction comprises a first locking script comprising a target Merkle tree portion corresponding to the Merkle tree, the first locking script configured, when executed together with a first unlocking script of a second blockchain transaction, to:
extract an r-portion from the first unlocking script,
generate a hash value derived from the extracted r-portion,
calculate a candidate Merkle tree portion based on the generated hash and a Merkle proof portion of the first unlocking script,
verify that the calculated candidate Merkle tree portion matches the target Merkle tree portion,
verify a signature portion of the first unlocking script based on a public key of the first unlocking script, and
making the first blockchain transaction available to one or more nodes of a blockchain network.
